(19) United States
(12) Patent Application Publication
(10) Pub. No.: US 2015/0343564 A1
(43) Pub. Date: Dec. 3, 2015

(54) METHOD FOR SELECTIVE LASER PROCESSING USING ELECTROSTATIC POWDER DEPOSITION

(71) Applicant: Siemens Energy, Inc., Orlando, FL (US)

(72) Inventors: Gerald J. Bruck, Oviedo, FL (US); Ahmed Kamel, Orlando, FL (US)

(73) Assignee: Siemens Energy, Inc., Orlando, FL (US)

(21) Appl. No.: 14/294,594

(22) Filed: Jun. 3, 2014

(51) Int. Cl. B23K 26/34; B05D 3/06; B22F 3/105; B05D 1/00

(52) U.S. Cl. CPC B23K 26/345; B05D 1/007; B05D 3/06; B22F 3/1055; B33Y 10/00

(57) ABSTRACT

A method including: electrostatically adhering powder (10) to a surface (30) of a substrate (12), wherein the powder includes particles (14) including a dielectric flux (16); and indexing an energy beam (70) across the powder to selectively melt the powder to form a pattern (72) of alloy under an overlying slag.

### FIELD OF THE INVENTION

The invention is related to selective laser processing of an electrostatically deposited powder including dielectric flux.

### BACKGROUND OF THE INVENTION

Additive manufacturing often starts by slicing a three dimensional representation of an object to be manufactured into very thin layers, thereby creating a two dimensional image of each layer. To form each layer, popular laser additive manufacturing techniques such as selective laser melting (SLM) and selective laser sintering (SLS) involve mechanical pre-placement of a thin layer of metal powder of precise thickness on a horizontal plane. After the powder is placed, a wiper is used to screed the layer, after which an energy beam, such as a laser, is indexed across the powder layer according to the two dimensional pattern of solid material for the respective layer. After the indexing operation is complete for the respective layer, the horizontal plane of deposited material is lowered and the process is repeated until the three dimensional part is completed. In order to protect the thin layers of fine metal particles from contaminants and from moisture pickup, the operation is performed under an atmosphere of inert gas, such as argon or nitrogen. These processes are limited in that they require a flat, horizontal surface which must be vertically adjusted, they are limited to two dimensional laser processing, they require a mechanically adjustable wiper whose wiping movement limits how a part can be built up, and they require an inert atmosphere. Consequently, there remains room in the art for improvement.

### BRIEF DESCRIPTION OF THE DRAWINGS

The invention is explained in the following description in view of the drawings that show:

FIG. 1 is a schematic representation of the process of electrostatically depositing a powder on a substrate.

FIG. 2 is a schematic representation of a particle composed of dielectric flux and alloy.

FIG. 3 is a schematic representation of the process of indexing an energy beam across powder deposited on the substrate during the process of FIG. 1.

FIG. 4 is a schematic representation of the process of indexing an energy beam across powder deposited on the substrate during the process of FIG. 1.

### DETAILED DESCRIPTION OF THE INVENTION

The present inventor has devised an improved method for selective laser processing of powders in an additive manufacturing process, such as selective laser melting (SLM) and selective laser sintering (SLS). Specifically, the inventor proposes to form a particle that is sufficiently dielectric to maintain an electrostatic charge. A powder composed of the particles is then electrostatically adhered to a substrate. The particle may be composed of a flux material only, or a flux material and an alloy. An energy beam such as, for example, a laser, is then selectively indexed across the powder to form a pattern of partially or fully melted alloy (i.e. processed alloy). In the case where the particles include only flux, the processed alloy (a pattern) is a remelted portion of the substrate that may be under repair. In the case where the particles include flux and alloy, the processed alloy includes the alloy in the particles.

When building a component through an additive manufacturing process, the pattern may be a two dimensional slice of a three dimensional object, as is the case in conventional processes. Alternatively, and advantageously, the pattern may be three dimensional section of the three dimensional object. This is made possible because the electrostatic charge adheres the powder to the substrate regardless of the orientation of the surfaces of the substrate, unlike the prior art. Overlying the pattern of processed alloy is a matching pattern of slag, formed by the dielectric flux that protects the pattern of processed alloy from the atmosphere during the melting process.

Upon completion of a respective indexing operation, the overlying pattern of slag is removed, a new layer of powder is electrostatically adhered to the substrate and to the previous pattern of processed alloy, and another energy beam indexing operation is commenced. This process is repeated until the three dimensional object is completed. The electrostatic adherence of the powder to the surfaces of the substrate effectively eliminates the effect of gravity on the powder. As a result, processing is not limited to horizontal surfaces, but instead can occur on surfaces at virtually any orientation. Further, since the dielectric flux and resultant slag also protect the processed alloy from the environment, inert gas is not necessary, which permits even greater freedom of movement and reduced costs. Consequently, the process is well suited for zero or negligible gravity environments, such as on board the space station or the like.

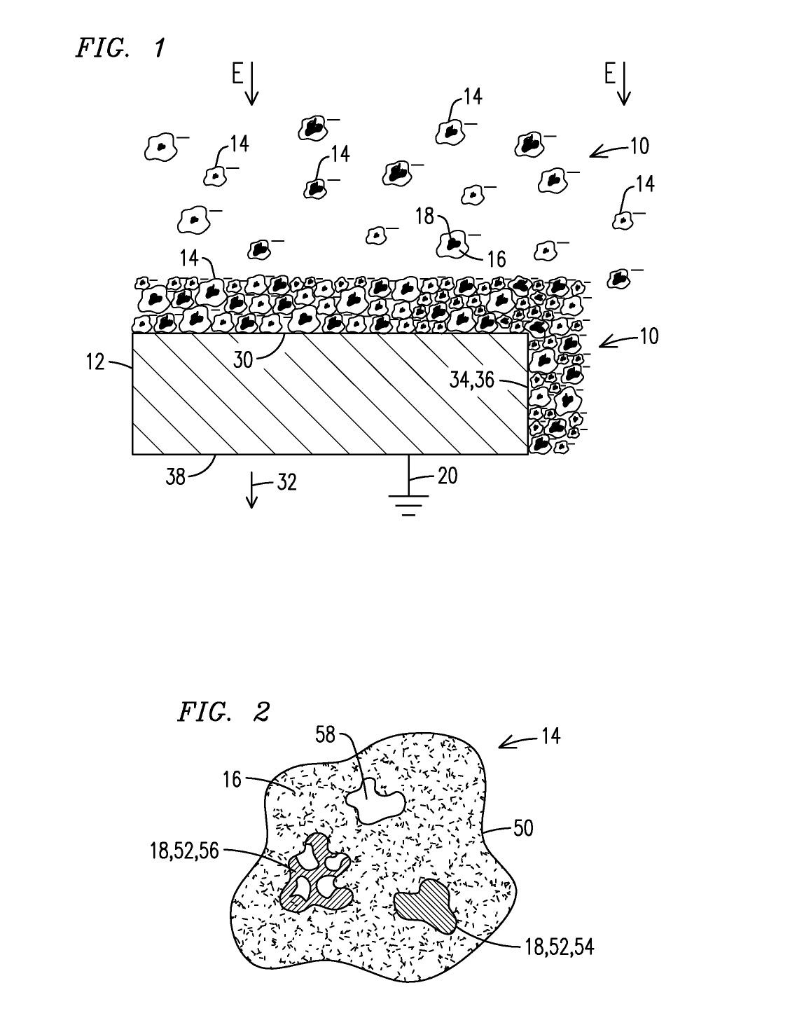

FIG. 1 depicts an exemplary embodiment of an additive manufacturing process using electrostatic deposition, where a powder 10 is being electrostatically deposited onto a substrate 12. In this exemplary embodiment, the powder 10 is composed of particles 14, each of which includes a dielectric flux 16 and an alloy 18. However, during a remelt repair process, the particles 14 may include only the dielectric flux 16. The substrate 12 is grounded via a ground 20. The particles 14 must be configured such that they hold an electrostatic charge that is sufficiently strong and lasts long enough to permit the subsequent energy beam processing. A particle composed solely of an alloy 18 would not suffice because the alloy, being a strong conductor, would bleed-off any imparted charge too quickly. However, many flux materials used in welding are not as electrically conductive. Instead, many of these flux materials are sufficiently dielectric that they can retain the requisite static charge for the requisite time. Since the particles 14 are composed of a mixture of the dielectric flux 16 and the alloy 18, a balance must be struck so that the resulting particle 14 is sufficiently dielectric to achieve the requisite static charge for the requisite time.

In addition, a weight of the alloy 18 in each particle must be limited so as not to exceed the holding force that can be achieved by the dielectric flux 16 in the same particle 14. Stated another way, on average the particles must be configured such that the adhering force they exert is sufficient to overcome the force of gravity on the alloy 18 (and dielectric flux 16) in the particles 14. The adhering force is associated with a magnitude of electrostatic charge imparted to the dielectric flux 16. Consequently, the particle's configuration must be such that it exerts sufficient adhering force for a given amount of electrostatic charge. Increasing the amount of electrostatic charge above a design-charge for a particle would increase the adhering force. This is acceptable so long as a minimum adhering force is attained.

The amount of adhering force needed may vary. For example, if a surface 30 of the substrate 12 is oriented horizontally (i.e. perpendicular to a direction 32 of gravitational force), then a minimal amount of adhering force is necessary because gravity will help hold the particle 14 in place. However, if a surface 34 is not perpendicular to the direction 32 of gravitational force, a relatively greater amount of adhering force will be necessary.

Adjusting the amount of adhering force exerted can be achieved in any number of ways. So long as the resulting particle 14 is sufficiently dielectric, it does not matter which way is used. For a particle 14 of a given physical and chemical composition, the adhering force can be adjusted during the process simply by adjusting a magnitude of electrostatic charge imparted to the particle 14. This can be done periodically and/or continuously and can be done so that the electrostatic charge that is imparted corresponds to an orientation of the surface 34 that is not perpendicular to the direction 32 of gravitational force and to which the particles 14 are being adhered at that point in the process. For example, a particle 14 adhering to a vertical surface 36 would require more minimum adhering force than a particle 14 adhering to the horizontal surface 30. Consequently, when energy beam processing is to occur on the vertical surface 36, the amount of electrostatic charge imparted to the particles 14 to be processed may be increased. Likewise, a particle adhering to an overhead surface 38 may require more minimum adhering force than the particle 14 adhering to the vertical surface 36. Consequently, when energy beam processing is to occur on the overhead surface 38, the amount of electrostatic charge imparted to the particles 14 adhering to the overhead surface 38 may be increased. Conversely, the amount of electrostatic charge imparted to the particles 14 may be reduced when going from the surface 34 that is not perpendicular to the direction 32 of gravitational force back to the horizontal surface 30.

The electrostatic charge may be adjusted as many times as necessary, including multiple times during a single application of powder 10 to the substrate 12, and for each of multiple applications of powder 10. The charge may be increased to accommodate local surface orientations during a single application of powder 10 to the substrate 12 when, for example, the substrate 12 includes surfaces at different orientations onto which the alloy 18 is to be melted. Likewise, the amount of electrostatic charge may be set for each application of powder 10 to the substrate 12 based on, for example, the maximum amount of electrostatic charge needed for the most difficult surface on which powder 10 is to be processed (melted). For example, if alloy 18 is to be processed on an overhead surface 38, then the amount of electrostatic charge may be set for that application of powder 10 to accommodate the need to adhere powder 10 to the overhead surface. If, during another application of powder 10, there are only generally horizontal surfaces, then the amount of electrostatic charge for that application may be lowered when compared to the amount of electrostatic charge needed when the overhead surface 38 is processed.

Examples of techniques to apply such dielectric powders to grounded metal surfaces include corona spray guns which create ionic bombardment and tribo guns which charge the powder by triboelectric friction. Fluidized beds of powder may also be electrostatically charged and powder coated on a grounded part as it is passed through the charged cloud of particles. An example electrical resistivity of the powder includes at least 100 micro-ohm-centimeters.

Alternately, the physical composition of the particles 14 can be adjusted, and this adjustment can also occur periodically and/or continuously throughout the process. For example, the amount of dielectric flux 16 in each particle can be increased or decreased to increase or decrease the amount of adhering force each particle 14 exerts. This can be done so the adhering force corresponds to an orientation of the surface onto which the particles 14 are adhered. A selection of powders 10, each having particles 14 of differing physical composition, may be kept on hand during the process in order to enable this tailoring of the physical composition of the particles 14 during the process.

An example weight percentage of the alloy 18 in each particle 14 includes a maximum of fifty (50) percent.

A distribution of the dielectric flux 16 and the alloy 18 within the particle 14 may also be controlled to control an amount of adherence. For example, as shown in FIG. 2, which is a cross section of a particle 14, it may be preferred to configure the particle 14 so that there is no alloy 18 on an outer surface 50 of the particle 14. The outer surface 50 is an exterior surface that is exposed to the environment. Exposed alloy, (i.e. alloy having a surface that is part of the outer surface 50) would tend to conduct electricity and not develop a surface charge. That is, the dielectric charge would bleed-off at a faster rate. Consequently, the particle 14 may be configured such that the dielectric flux 16 completely engulfs the alloy 18, as shown in FIG. 2. Alternately, the particle 14 may be configured such that not more than a threshold percentage of a surface area of the outer surface 50 may be alloy 18. Furthermore, as in the case for remelt repair operations, particles may be configured to include with flux alone.

Each particle 14 may include one or more alloy bodies 52. The physical composition of the alloy bodies 52 may be the same or may vary within a given particle 14 and from particle 14 to particle 14 within a given powder 10. For example, an alloy body 54 may be of a fully densified metallurgy. Alternately, an alloy body 56 may be partly sintered. If partly sintered, the alloy body 56 may have a porosity as large as eighty (80) percent. Each particle 14 may optionally include voids 58 that may reduce a weight of the particle 14, which aids the adhering force in overcoming gravity. Particles 14 with voids may, for example, exhibit a porosity as large as eighty (80) percent. An overall size of the particles 14 may also be controlled to produce optimum results. For example, the particles 14 may be configured such that a largest dimension is smaller than 50 microns. Limiting a size of the particles 14 may increase a surface area to mass ratio within the powder 10. This may improve adherence and permit the powder 10 to flow into restricted geometries of the substrate 12 better, thereby improving a coverage of the powder 10 on the substrate 12.

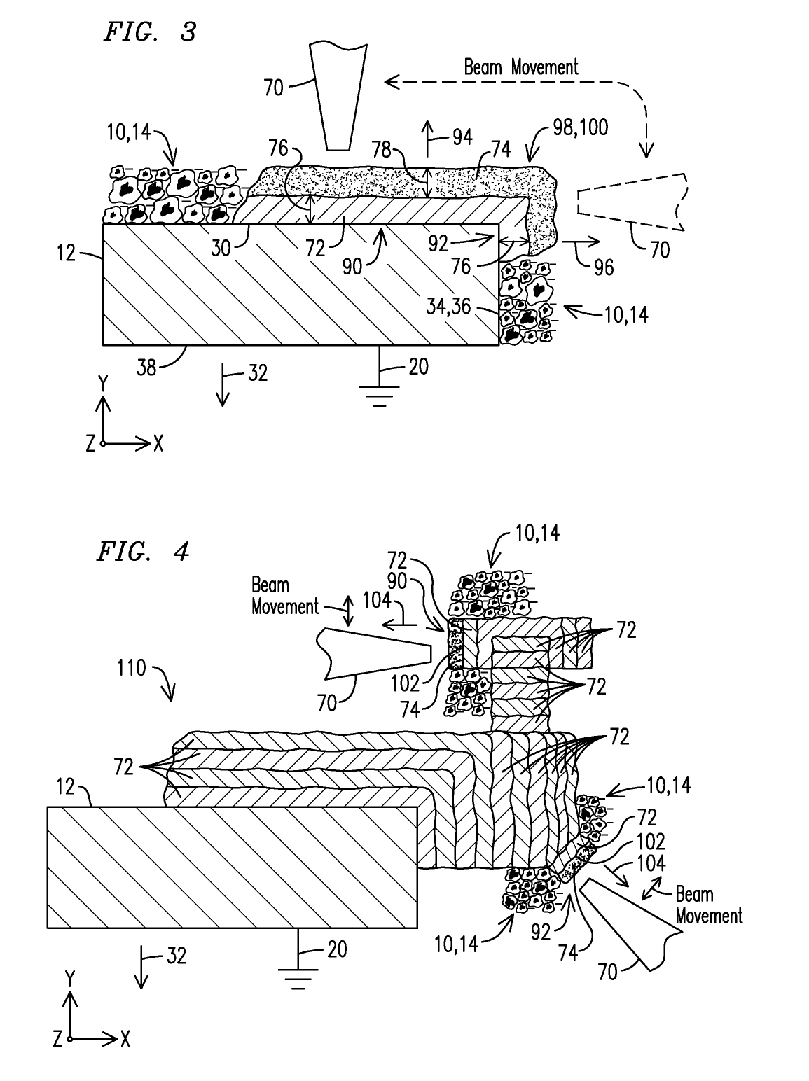

FIG. 3 depicts an energy beam 70 that has indexed across the powder 10 to form a partly or fully melted and then solidified alloy pattern 72 over which lies a slag pattern 74. The alloy pattern 72 is composed of the alloy bodies 56 that were partly or fully melted by the energy beam 70, and the slag pattern 74 is composed of the dielectric flux 16 that was melted by the energy beam 70. The alloy pattern 72 takes a shape having a thickness 76 that is generally oriented normal to the substrate 12 or previous pattern to which it applied, where the thickness 76 is measured. Likewise, the slag pattern 74 also has a thickness 78 that is normal to the alloy pattern where the thickness 78 is taken.

Under conventional processes, the thickness at all locations of the alloy pattern would be oriented parallel to the direction 32 of gravitational force. Consequently, the alloy pattern 72 is considered to extend in two dimensions, along the X and Z axes. However, as can be seen, the alloy pattern 72 formed in this figure is not limited in this manner. Instead, a first portion 90 of the alloy pattern 72 extends along the X and Z axes, but a second portion 92 of the alloy pattern 72 extends along the Y and Z axes. The first portion 90 and the second portion 92 extend in directions transverse to each other. Likewise, the thickness 76 of the first portion 90 extends in a first direction 94, which, in this case, is parallel to the direction 32 of gravity. The thickness 76 of the second portion 92 extends in a second direction 96, and the first direction 94 and the second direction 96 are not parallel to each other. This alloy pattern 72 thereby forms a three dimensional pattern 98, which cannot occur using the prior art techniques.

As shown, the first portion 90 and the second portion 92 may be connected to each other, thereby forming a monolithic alloy pattern 72. Alternately, the first portion 90 and the second portion 92 may be discrete from each other, thereby forming an alloy pattern 72 composed of plural portions 90, 92.

In addition to indexing the energy beam 70 in all three dimensions, the substrate 12 can be moved along all three axes X, Y, and Z, and/or rotated around all three axes X, Y, and Z. Likewise, during the process both the energy beam 70 and the substrate 12 can be moved with respect to each other along all three axes X, Y, and Z and/or rotated with respect to each other around all three axes X, Y, and Z. The substrate 12 can be moved before, during, and/or after the indexing operation while the powder 10 remains adhered to the substrate 12. This is possible so long as sufficient electrostatic charge is imparted to the powder 10 that the powder 10 will continue to adhere to the substrate 12 regardless of how the substrate 12 is rotated. For example, the powder 10 applied to a horizontal surface may have an electrostatic charge imparted to it that is sufficient to adhere the powder 10 to an overhead surface 38. This way, regardless of how the substrate 12 is moved before, during, and/or after the indexing operation, the powder 10 continues to adhere to the substrate 12.

FIG. 4 shows the substrate 12 after several adhering and indexing operations. During the indexing operation shown, at least one energy beam 70 is forming the first portion 90 and the second portion 92 which, together, form the three dimensional alloy pattern 72 having an associated three dimensional surface 102 composed of plural portions 90, 92 that are not connected to each other. An indexing operation may be considered all of the indexing that is done before the slag pattern 74 is removed and more powder 10 is adhered for subsequent processing. For any given location, a direction of buildup 104 is akin to an orientation of the thickness 76 at the given location. Consequently, the substrate can be built-up along any and all of the three axes X, Y, and Z during one indexing operation. In this figure a component 110 being formed includes the substrate 12 and one or more alloy patterns 72. Uniquely, the component 110 may be built-up along two different directions during one indexing operation, and this can occur repeatedly during subsequent indexing operations. In addition, it can be seen that the energy beam 70 is oriented upward to form the second portion 92 on a surface that is at an angle between vertical and overhead. These actions would not be possible using conventional processing techniques.

From the foregoing it can be seen that the inventor has devised a simple, clever, and easy to implement additive manufacturing process that enables significantly more flexibility and less complexity than prior processes. Specifically, all surface geometries, not just flat, can be processed. In addition, surfaces in any orientation can be processed. No wiper arm is used, and so component features do not limit the coating process. This process avoids mechanical tooling. The part may remain static, or the laser may be static and the part moved, or both may move relative to each other. Further, no inert gas is required since the dielectric flux provides the necessary shielding during the energy beam processing. Consequently, this represents an improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method comprising:
electrostatically adhering powder to a surface of a substrate, wherein the powder comprises particles comprising a dielectric flux; and
indexing an energy beam across the powder to selectively melt the powder to form a pattern of alloy under an overlying slag.

2. The method of claim 1, wherein the powder comprises an electrical resistivity of at least 100 micro-ohm-centimeters.

3. The method of claim 1, wherein a largest dimension of the particles is smaller than 50 microns.

4. The method of claim 1, further comprising rotating the substrate about at least one of an X-axis and a Z-axis before or while using the energy beam, wherein the X-axis and the Z-axis are both horizontal and at right angles to each other, and providing sufficient electrostatic charge to maintain adherence of the powder to the surface while rotating the substrate.

5. The method of claim 1, further comprising repeating the adhering and indexing steps, and adjusting a magnitude of an electrostatic charge imparted to the particles to correspond with an orientation of the surface of the substrate to which the dielectric flux and the alloy are being adhered.

6. The method of claim 1, wherein the particles further comprise an alloy.

7. The method of claim 6, wherein a weight percent of the alloy in the particles is less than fifty (50) percent.

8. The method of claim 6, wherein the alloy comprises a fully densified metallurgy.

9. The method of claim 6, wherein the alloy comprises a porosity as large as eighty (80) percent.

10. The method of claim 6, wherein the alloy comprises a partly sintered metallurgy.

11. The method of claim 10, wherein the partly sintered metallurgy comprises a porosity as large as eighty (80) percent.

12. The method of claim 6, wherein a surface of the pattern forms a three-dimensional shape.

13. The method of claim 12, wherein the pattern of alloy comprises a first portion and a second portion that is discrete from the first portion, wherein surfaces of the respective portions form the three-dimensional shape.

14. The method of claim 6, further comprising repeating the adhering and melting operations, and adjusting a composition of the dielectric flux and the alloy to correspond with an orientation of the surface of the substrate to which the dielectric flux and the alloy are being adhered.

15. The method of claim 6, further comprising repeating the adhering and indexing operations to form a component comprising the substrate and at least one alloy pattern, and building up the component in two different dimensions during one indexing of the energy beam.

16. A method comprising:
electrostatically charging dielectric flux;
adhering the dielectric flux to a surface of a substrate; and
melting the dielectric flux and an alloy with an energy beam.

17. The method of claim 16, wherein the dielectric flux is in particle form, and wherein the alloy is incorporated into the flux particles.

18. The method of claim 16, wherein a surface of the melted alloy comprises a three-dimensional shape.

19. The method of claim 16, wherein the surface of the substrate is an overhead surface.

20. The method of claim 16, further comprising rotating the substrate about at least one of an X-axis and a Z-axis before or while using the energy beam, wherein the X-axis and the Z-axis are both horizontal and at right angles to each other, and ensuring the dielectric flux remains adhered to the surface of the substrate during the rotation.
